(19) United States
(12) Patent Application Publication
(10) Pub. No.: US 2006/0123924 A1
(43) Pub. Date: Jun. 15, 2006

(54) Coriolis mass flowmeter

(76) Inventors: Chris Rolph, Hartwell (GB); Neil Harrison, Duston (GB); Yousif Hussain, Weston Favell (GB)

Correspondence Address: CESARI AND MCKENNA, LLP, 88 BLACK FALCON AVENUE, BOSTON, MA, 02210, US

(21) Appl. No.: 11/299,613

(22) Filed: Dec. 12, 2005

(30) Foreign Application Priority Data
Dec. 14, 2004 (DE) 10 2004 060 420.7

(51) Int. Cl. G01F 1/84

(52) U.S. Cl. 73/861.357

(57) ABSTRACT

A Coriolis mass flowmeter includes a measuring tube for carrying a flowing medium, a vibration generator for exciting circumferential vibrations of the measuring tube, a vibration sensor for registering circumferential vibrations of the measuring tube and two mass rings fixed to the measuring tube, the mass rings running circumferentially around the measuring tube and the vibration generator and the vibration sensor being provided between the two mass rings. A cylinder connecting the two mass rings is provided to enable the flowmeter to exhibit a high zero-point stability.

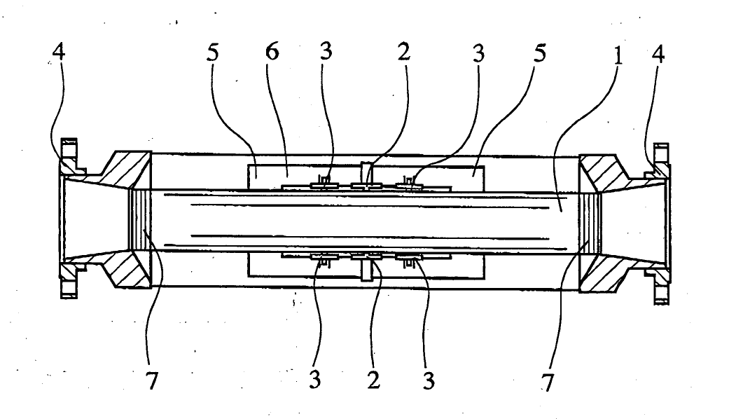

### BACKGROUND OF THE INVENTION

1. Field of the Invention

This invention relates to a Coriolis mass flowmeter, having a measuring tube for carrying a flowing medium, a vibration generator for exciting circumferential vibrations of the measuring tube, a vibration sensor for registering circumferential vibrations of the measuring tube and two mass rings affixed to the measuring tube, the mass rings running circumferentially around the measuring tube and the vibration generator and the vibration sensor being provided between the two mass rings.

2. Description of the Prior Art

Such a Coriolis mass flowmeter is known, for example from WO 95/16897 A2. In the Coriolis mass flowmeter described there, provision is likewise made to excite circumferential vibrations of the measuring tube, that is to say those vibrations in which the cross section of the measuring tube is changed geometrically as a result of the vibration, at least in the region of the vibration excitation.

A Coriolis mass flowmeter in which a similar excitation of circumferential vibrations of the measuring tube is provided is described in WO 01/92833. The Coriolis mass flowmeter described there is distinguished in particular by the fact that the measuring tube has a wall thickness which is substantially smaller than the radius of the measuring tube, so that circumferential oscillations which are associated with deformation of the outer surfaces of the measuring tube can be generated particularly simply. Furthermore, in this Coriolis mass flowmeter, provision is made for the length of the measuring tube to be at least of the same order of magnitude as the radius of the measuring tube. The Coriolis mass flowmeter described in WO 01/92833 A1, therefore, has a measuring tube such that, on the basis of its short length and its large clear width, the results in only slight throttling of the flow of the medium and therefore exhibits only small interfering effects on the flow in the pipeline system into which the Coriolis mass flowmeter is incorporated.

In the Coriolis mass flowmeter described in WO 95/16897 A2, provision is further made to fit a mass ring in each case in the end regions of the measuring tube. These mass rings, extending circumferentially around the measuring tube, are intended to be used for vibration isolation, that is to say for the circumferential vibrations excited not to escape from the central region of the measuring tube, in which typically the vibration generator and the vibration sensor are located. In addition to the increased mass resulting from the mass rings, at the location at which they are fitted, an increase in the stiffness of the measuring tube results, which further improves the desired vibration isolation. To this extent, it may also be pointed out that the mass rings do not have to be devices additionally fitted to the measuring tube; specifically, the mass rings can also be formed in one piece with the measuring tube.

As a result of the above-described use of mass rings, the measurement accuracy of the Coriolis mass flowmeter can already be very good. However, it has been shown that, in particular the zero-point stability of a Coriolis mass flowmeter configured in this way is not entirely satisfactory.

### SUMMARY OF THE INVENTION

The object of the invention is, therefore, to specify a Coriolis mass flowmeter of this type which exhibits high zero-point stability.

On the basis of the Coriolis mass flowmeter described at the beginning, this object is achieved in that a cylinder connecting the two mass rings is provided. According to the invention, the measuring tube of the Coriolis mass flowmeter has an additional device, namely a cylinder, which is connected to the two mass rings. In this case, the cylinder preferably reaches exactly from one measuring ring to the other.

In principle, the cylinder could be formed in one piece with the mass rings and/or the measuring tube. According to a preferred embodiment of the invention, however, provision is made for the cylinder at least not to be formed in one piece with the measuring tube. However, a one-piece formation of the mass rings and the cylinder is readily possible.

According to a preferred embodiment of the invention, provision is further made for the cylinder connecting the two mass rings, and therefore also enclosing the vibration generator and the vibration sensor, to serve as an abutment for the vibration generator and for the vibration sensor. In this connection, it should be noted that a multiplicity of vibration generators and/or vibration sensors can also be provided, it then being possible for the cylinder to serve also as an abutment for a plurality of vibration generators and/or vibration sensors.

Furthermore, according to a preferred embodiment of the invention, provision is made for the Coriolis mass flowmeter to be provided with a housing, which encloses the measuring tube and the cylinder and is connected to the measuring tube in the two end regions of the latter. This shows that the cylinder is substantially not intended to perform any housing function but is used substantially for further improved vibration isolation, which ultimately leads to considerably improved zero-point stability.

It has been shown that it is advantageous if the width of the measuring rings and preferably also the wall thickness of cylinder are in each case greater than the wall thickness of the measuring tube. To this extent, according to a preferred embodiment of the invention, provision is made for the width of the mass rings, preferably also the wall thickness of the cylinder, to be greater by at least the factor 10, preferably by at least the factor 20, than the wall thickness of the measuring tube. In this case, it is quite particularly preferred for the wall thickness of the cylinder to correspond substantially to the width of the mass rings.

As already explained previously, the Coriolis mass flowmeter currently described is suitable for an operation such that circumferential vibrations of the measuring tube are generated, that is to say those vibrations in which the cross section of the measuring tube changes geometrically during the vibrations. In this connection, according to preferred embodiment of the invention, provision is further made for the measuring tube to have a sufficiently small wall thickness in relation to its radius, in order to permit circumferential vibration of the measuring tube that can be excited by the vibration generator and registered by vibration sensor, including the associated Coriolis vibrations. In this case, it is particularly preferred for the wall thickness of the measuring tube to be smaller by a factor 50 than the radius of the measuring tube.

Furthermore in this connection, for a measuring tube diameter of 100 mm it is particularly preferred for the wall thickness to be less than or equal to 2.0 mm, preferably less than or equal to 1.0 mm. Furthermore, according to a preferred embodiment of the invention, provision is made for the length of the measuring tube to be of the order of magnitude of the radius of the measuring tube, which means that only a slight throttling point for the flowing medium is produced. The corresponding is possible in particular since no transverse vibrations of the measuring tube overall, such as in the case of a vibrating string, but only a circumferential vibration of the measuring tube, that is a deformation of the outer surfaces of the measuring tube, takes place, which is made easier by the small wall thickness of the measuring tube. In this case, finally, according to a preferred embodiment of the invention, provision is made for the radio of the length of the measuring tube to the radius of the measuring tube to be less than or equal to 6, preferably less than or equal to 4.

Finally, a preferred embodiment of the invention provides that the measuring tube have at its two ends in each case a coupling device for coupling the measuring tube to a pipeline system, the coupling devices being formed in such a way that a “soft” coupling of the measuring tube to the pipeline system is ensured. In particular, a “soft” coupling of this type between the measuring tube and the pipeline system is achieved by bellows being provided as coupling devices. The transmission of vibrations from the measuring tube of the Coriolis mass flowmeter into the pipeline system, and therefore possible interfering vibrations coupling back into the measuring tube, are therefore reduced further.

In detail, there is now a large number of possible ways of configuring and developing the Coriolis mass flowmeter according to the invention. For this purpose, reference is made to the dependent claims and also to the following description of a preferred exemplary embodiment of the invention with reference to the drawing.

### BRIEF DESCRIPTION OF THE DRAWINGS

In the drawing, the single figure is a longitudinal sectional view of a Coriolis mass flowmeter according to a preferred embodiment of the invention.

### DETAILED DESCRIPTION OF AN ILLUSTRATIVE EMBODIMENT

The Coriolis mass flowmeter according to the preferred embodiment of the invention, which can be seen from the drawing figure, has a measuring tube 1 which, in operation of the Coriolis mass flowmeter, has a medium, not further illustrated, flowing through it. In order to excite vibrations of the measuring tube 1, two vibration generators 2 are provided, specifically located exactly opposite each other, exactly in the middle of the measuring tube 1 as viewed in the longitudinal direction of the measuring tube 1.

As viewed in the longitudinal direction of the measuring tube 1, two pairs of vibration sensors 3 are provided, in each case offset in relation to the two vibration generators 2. Two vibration sensors 3 of a respective pair are likewise located opposite each other, the two pairs each having two vibration sensors 3 in each case being provided at the same distance from the pair having two vibration generators 2, as viewed in the longitudinal direction of the measuring tube 1. Overall, on one side of the measuring tube 1, the vibration generator 2 provided and the vibration sensors 3 extend on a line which runs parallel to the longitudinal axis of the measuring tube 1.

Furthermore, according to the currently described preferred embodiment of the invention, provision is made for the two mutually opposite vibration generators 2 to have the same mass and also for all four vibration sensors 3 to have the same mass, so that overall a balanced measuring tube 1 is achieved. In addition, the vibration generators 2 and the vibration sensors 3 are constructed and arranged in such a way that their centers of gravity lie very close to the wall of the measuring tube 1. In this way, the mass moment of inertia of the vibration generators 2 and the vibration sensors 3 plays little part in the circumferential vibrations of the measuring tube 1, so that these are only little affected by the vibration generators 2 and the vibration sensors 3.

Circumferential vibrations of the measuring tube 1 are generated with the vibration generators 2. For this purpose, the measuring tube 1 is provided which has a sufficiently low wall thickness in relation to its radius in order to permit circumferential vibrations of the measuring tube that can be excited by the vibration generators 2 and registered by the vibration sensors 3, it also being possible for Coriolis vibrations to be registered. In practical terms, provision is made for the wall thickness of the measuring tube 1 to be smaller by at least the factor 50 than the radius of the measuring tube, the wall thickness of the measuring tube being about 1.0 mm. Therefore, as can be gathered from the figure, a short length of the measuring tube 1 can be achieved which is of the same order of magnitude as the radius of the measuring tube 1.

As in the case of conventional Coriolis mass flowmeters, flanges 4 are provided at the ends of the measuring tube 1, by means of which the Coriolis mass flowmeter in accordance with the described preferred embodiment of the invention may be incorporated into a pipeline system, not further illustrated. In addition, at both its ends, the measuring tube 1 in each case has a bellows 7 for connecting the measuring tube 1 to the pipeline system. As a result, a “soft” coupling of the measuring tube 1 to the pipeline system is ensured. The transmission of vibrations from the measuring tube 1 of the Coriolis mass flowmeter into the pipeline system, and therefore interfering vibration possibly coupled back into the measuring tube 1, are therefore reduced further. Finally, in a manner similar to that in conventional Coriolis mass flowmeters, a housing 7 enclosing the measuring tube 1 and the cylinder 6 is also provided and is connected to the measuring tube 1 in the two end regions of the latter.

It is now important in the Coriolis mass flowmeter according to the described preferred embodiment of the invention that two end masses 5 are provided, which are fixed to the measuring tube 1 at the same distance form the center of the measuring tube 1 such that they run circumferentially around the measuring tube 1 and enclose the vibration generators 2 and also the vibration sensors 3. Formed in one piece with these mass rings 5 is a cylinder 6, which connects the two mass rings 5 to each other, reaches exactly from one mass ring 5 to the other mass rings 5 and the process serves as an abutment for the vibration generators 2 and the vibration sensors 3. In this case, it is also possible to gather from the figure that the width of the mass rings 5 corresponds substantially to the wall thickness of the cylinder 6, and in the present case, is specifically around 1.5 cm. At the given wall thickness of the measuring tube 1 of about 1.0 mm, the wall thickness of the cylinder and the width of the mass rings 5 are, therefore, greater by more than the factor 50 than the wall thickness of the measuring tube 1. Overall, a Coriolis mass flowmeter of this type is therefore achieved whose zero-point stability is very high.

1. A Coriolis mass flowmeter, having a measuring tube with two end regions and for carrying a flowing medium, a vibration generator for exciting circumferential vibrations of the measuring tube, a vibration sensor for registering circumferential vibrations of the measuring tube and two mass rings fixed to the measuring tube, the mass rings running circumferentially around the measuring tube and the vibration generator and the vibration sensor being provided between the two mass rings wherein a cylinder connects the two mass rings.

2. The Coriolis mass flowmeter according to claim 1 wherein the cylinder forms abutments for the vibration generator and for the vibration sensor.

3. The Coriolis mass flowmeter according to claim 1 or 2, and further including a housing enclosing the measuring tube and the cylinder, said housing being connected to the measuring tube in the two end regions of the latter.

4. The Coriolis mass flowmeter according to claims 1 or 2, wherein the width of the mass rings, and preferably also the wall thickness of the cylinder, is greater by at least a factor 10, than the wall thickness of the measuring tube.

5. The Coriolis mass flowmeter according to claim 1 or 2, wherein the wall thickness of the cylinder corresponds substantially to the width of the mass rings.

6. The Coriolis mass flowmeter according to claim 1 or 2 wherein the wall thickness of the measuring tube is smaller by at least a factor 50 than the radius of the measuring tube.

7. The Coriolis mass flowmeter according to claim 1 or 2, wherein the wall thickness of the measuring tube is less than or equal to 2.0 mm.

8. The Coriolis mass flowmeter according to claim 1 or 2, wherein the length of the measuring tube is of the order of magnitude of the radius of the measuring tube.

9. The Coriolis mass flowmeter according to claim 8 wherein the ratio of the length of the measuring tube to the radius of the measuring tube is less than or equal to 6.

10. The Coriolis mass flowmeter according to claim 1 or 2, wherein at its two ends, the measuring tube is in each case provided with a coupling device for coupling the measuring tube to a pipeline system, the coupling devices ensuring a soft coupling of the measuring tube to the pipeline system.

11. The Coriolis mass flowmeter according to claim 10 wherein said coupling devices are bellows.
